(19) United States
(12) Patent Application Publication
(10) Pub. No.: US 2010/0316383 A1
(43) Pub. Date: Dec. 16, 2010

(54) WAVELENGTH DIVISION MULTIPLEXED-PASSIVE OPTICAL NETWORK APPARATUS

(75) Inventors: Hyun Soo KIM, Daejeon (KR); Kisoo Kim, Daejeon (KR); Dong Churl Kim, Daejeon (KR); Byung-Seok Choi, Daejeon (KR); O-Kyun Kwon, Daejeon (KR); Dae Kon Oh, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/582,211

(22) Filed: Oct. 20, 2009

(30) Foreign Application Priority Data
Jun. 16, 2009 (KR) 10-2009-0053536

(51) Int. Cl. H04J 14/02

(52) U.S. Cl. 398/79

(57) ABSTRACT

Provided is a wavelength division multiplexed-passive optical network (WDM-PON) apparatus. The WDM-PON includes an optical source unit, an optical mux, and a chirped Bragg grating. The optical source unit generates an optical signal. The optical mux receives the optical signal from the optical source unit through one end of the optical mux, multiplexes the optical signal, and outputs the multiplexed optical signal. The chirped Bragg grating is connected to the other end of the optical mux. The chirped Bragg grating again reflects the optical signal having passed the optical mux to re-input a certain portion of the optical signal into the optical mux and the optical source unit. The optical mux performs a spectrum slicing on the re-inputted optical signal and operates the optical source unit using a channel wavelength of the optical mux as a main oscillation wavelength.

### CROSS-REFERENCE TO RELATED APPLICATIONS

This U.S. non-provisional patent application claims priority under 35 U.S.C. §119 of Korean Patent Application No. 10-2009-0053536, filed on Jun. 16, 2009, the entire contents of which are hereby incorporated by reference.

### BACKGROUND

The present disclosure herein relates to Wavelength Division Multiplexed-Passive Optical Network (WDM-PON) apparatuses, and more particularly, to WDM-PON apparatuses based on self-injection locking.

With the development of the high-speed internet and multimedia service, a great deal of research is being conducted on Fiber To The Home (FTTH) technologies that connect a telephone office to the home using an optical fiber to provide a large amount of data. Various optical communication networks are being studied to realize the FTTH technology, the most important goal of which is not only to transmit large-capacity data but also to lower the cost of the transmission.

Generally, a Passive Optical Network (PON) is excellent in the management and maintenance of the network in terms of the characteristics of a passive device, and is economic because many subscribers share an optical fiber.

A Wavelength Division Multiplexing (WDM) technology refers to a communication technology that multiplexes an optical carrier signal in a single optical fiber using lasers with different wavelengths to deliver different signals. The WDM technology enables capacity increase of communication data, and two-way communication along one optical fiber line.

WDM-PON apparatus is a network that provides an access by discriminating a wavelength of an optical signal used in the up-stream data transmission according to an Optical Network Unit (ONU) and a wavelength of an optical signal used in the down-stream data transmission according to a Central Office (CO) to group a plurality of ONUs. The WDM-PON apparatus distributes optical signals having a plurality of wavelengths that are coupled using an optical signal distributor (optical mux/demux) into each physical link. Multiplexing of up/down-stream channels is achieved by the optical signal distributor.

In the WDM-PON technology, different wavelengths are assigned for network units, respectively. Accordingly, security and extensibility are excellent. However, the WDM-PON requires an optical source such as expensive Distributed Feedback Laser Diode (DFB LD) that has different wavelength for each network unit. The WDM-PON has an inventory control limitation in that different optical sources must be prepared for each network unit against failure, resulting in deduction of price competitiveness. Accordingly, Reflective Semiconductor Optical Amplifier (RSOA) and injection locking Fabry-Perot laser diode are studied as a low-cost optical source of ONU, which is a colorless optical source as a low-cost optical source of WDM-PON apparatus.

The WDM-PON apparatus includes an optical transmission unit including optical transmitters that generate signals of a plurality of channels (for example, sixteen channels), respectively, a multiplexer multiplexing each channel signal of the optical transmission unit, an optical fiber delivering an optical signal, demultiplexer separating a multiplexed signal into a channel signal, and an optical reception unit including a plurality of optical receivers that detect each channel signal.

In the WDM-PON apparatus, a down-stream channel signal is generated according to the pass wavelength of ONU located at a remote site, and the generated signal is multiplexed through a multiplexer. Here, an Arrayed Waveguide Grating (AWG) is used as the wavelength division optical mux/demux. However, a WDM-PON apparatus using a colorless optical source has a limitation in that an additionally external seed source is required to operate the colorless optical source in a single wavelength.

### SUMMARY

Embodiments of the inventive concept provide wavelength division multiplexed-passive optical network (WDM-PON) apparatuses including a chirped Bragg grating, an optical mux, and a colorless optical source such as Fabry-Perot laser diode or a reflective semiconductor optical amplifier. In the WDM-PON apparatus, an optical signal generated from the colorless optical source is reflected at the chirped Bragg grating through the optical mux, and the optical mux performs a spectrum slicing on the reflected optical signal to feed back the an optical signal of a channel wavelength to the colorless optical source for self-injection interlocking.

Embodiments of the inventive concept provide wavelength division multiplexed-passive optical network apparatuses including: an optical source unit generating an optical signal; an optical mux receiving the optical signal from the optical source unit through one end of the optical mux, multiplexing the optical signal, and outputting the multiplexed optical signal; and a chirped Bragg grating connected to the other end of the optical mux, wherein the chirped Bragg grating again reflects the optical signal having passed the optical mux to re-input a certain portion of the optical signal into the optical mux and the optical source unit, and the optical mux performs a spectrum slicing on the re-inputted optical signal and operates the optical source unit using a channel wavelength of the optical mux as a main oscillation wavelength.

In some embodiments, the chirped Bragg grating may have a grating period that is gradually reduced from an entrance of the chirped Bragg grating to reflect a long wavelength first.

In other embodiments, the optical source unit may provide a high power at the center wavelength, and the chirped Bragg grating may provide a low reflectance at the center wavelength, thereby allowing the optical source unit and the chirped Bragg grating to provide a uniform power with respect to a certain band.

In still other embodiments, the optical source unit may include a gain region and a phase shift region, the phase shift region controlling a phase of the optical signal reflected from the chirped Bragg grating.

In even other embodiments, the optical source unit may include a gain waveguide and a passive waveguide, the phase shift region formed on the gain waveguide or the passive waveguide and controlling the phase of the optical signal reflected from the chirped Bragg grating.

In yet other embodiments, the total length of the optical source unit, the optical mux, and the chirped Bragg grating may be an integer multiple of an oscillation wavelength of the optical source unit.

In further embodiments, the chirped Bragg grating may be a chirped optical fiber grating, and the chirped optical fiber grating may be integrally formed with the optical mux.

In still further embodiments, the optical source unit may include at least one of a Fabry-Perot laser diode (FP-LD), a reflective semiconductor optical amplifier (RSOA), a superluminescent diode (SLD), and a vertically-cavity surface-emitting laser (VCSEL).

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the figures:

FIG. 1 is a diagram illustrating a Wavelength Division Multiplexed-Passive Optical Network (WDM-PON) apparatus according to an embodiment;

FIGS. 2A through 2C are diagrams illustrating the spectrum characteristics of an optical source unit, an optical mux/demux, and a chirped Bragg grating according to an embodiment;

FIGS. 3A through 3C are diagrams illustrating the dispersion characteristics of an optical source unit, an optical fiber, and a chirped Bragg grating according to an embodiment;

FIG. 4 is a diagram illustrating a WDM-PON apparatus according to another embodiment; and

FIG. 5 is a cross-sectional view illustrating an optical source unit according to an embodiment.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

A great deal of research has been conducted on a Wavelength Division Multiplexed-Passive Optical Network (WDM-PON) apparatus within a transmission distance of approximately 20 km or so. However, recent research is being conducted on a long-reach WDM-PON that allows a transmission distance of more than 80 km.

In order to achieve the long-reach WDM-PON, the top-priority is to solve the dispersion caused by an optical fiber.

In a wavelength band of about 1550 nm of an optical fiber of a general standard signal mode, a short wavelength is more quickly propagated than a long wavelength. That is, an optical pulse having finite linewidth and time may overlap an adjacent optical pulse due to a dispersion of an optical fiber. The dispersion of the optical fiber may restrict the transmission distance if the transmission rate or the channel linewidth in the optical pulse is increased.

Generally, each channel linewidth of optical mux/demux in WDM-PON may be approximately a half of a channel spacing. For example, the channel linewidth may have a relatively broad channel linewidth of approximately 0.1 nm to approximately 1 nm Accordingly, an additional dispersion compensation device is necessary for a long-distance transmission due to the dispersion caused by the broad linewidth.

Hereinafter, exemplary embodiments of the inventive concept will be described in detail with reference to the accompanying drawings.

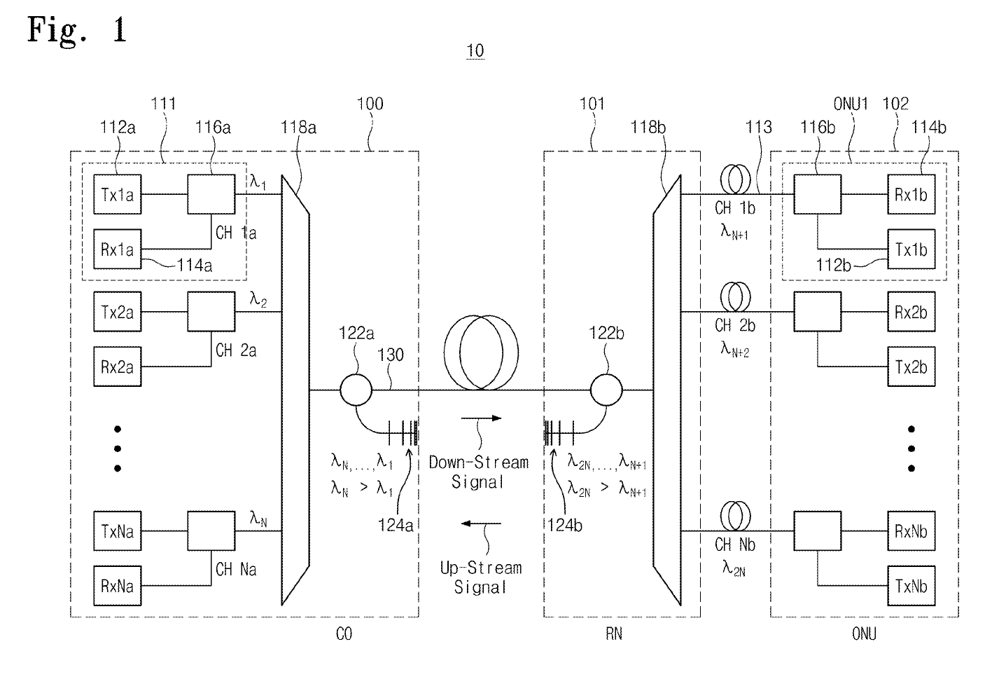

FIG. 1 is a diagram illustrating a Wavelength Division Multiplexed-Passive Optical Network (WDM-PON) apparatus according to an embodiment.

Referring to FIG. 1, a WDM-PON apparatus 10 may include a first optical source unit 112a, a first optical mux/demux 118a, and a first chirped Bragg grating 124a. The first optical source unit 112a generates an optical signal. The first optical mux/demux 118a receives the optical signal from the first optical source unit 112a via one end thereof, and multiplexes the optical signal to output. The first chirped Bragg grating 124a is connected to the other end of the first optical mux/demux 118a. The first chirped Bragg grating 124a reflects again the light having passed the first optical mux/demux 118a to return certain portions of the light to the first optical mux/demux 118a and the first optical source unit 112a. The first optical mux/demux 118a performs a spectrum slicing on the returned light. The first optical mux/demux 118a operates the first optical source unit 112a using a channel wavelength of the first optical mux/demux 118a as a main oscillation wavelength. Thus, the first optical source unit 112a is self-injection locked.

The WDM-PON apparatus 10 includes a central office (CO) 100, an optical fiber 130, a remote node (RN) 101, and an optical network unit (ONU) 102.

The central office 100 includes a first optical source unit 112a transmitting a down-stream signal, a first optical reception unit 114a receiving an up-stream signal, a first optical filter 116a, and a first optical mux/demux 118a. A plurality of first optical source units 112a may be provided. The first optical source units Tx1a, Tx2a, . . . , TxNa are connected to each channel CH1a, CH2a, . . . , CHNa of the first optical mux/demux 118a.

The central office 100 may include the first chirped Bragg grating 124a and a first optical distributor 122a. The central office 100 provides a down-stream signal to a second optical mux/demux 118b in the remote node 101, and receives an up-stream signal from the remote node 101.

The first optical source unit 112a is a colorless optical source. The first optical source unit 112a is an optical amplifier that receives a current to generate a broad-band optical signal. The first optical source unit 112a may include at least one of a Fabry-Perot Laser Diode (FP-LD), a Reflective Semiconductor Optical Amplifier (RSOA), a SuperLuminescent Diode (SLD), and a Vertically-Cavity Surface-Emitting Laser (VCSEL). The optical signal of the first optical source unit 112a passes the first optical mux/demux 118a and is partially reflected from the first chirped Bragg grating 124a. The first optical source unit 112a receives light of a channel wavelength from the first optical mux/demux 118a. Thus, the first optical source unit 112a oscillates in the channel wavelength. The light of the channel wavelength provided to the first optical source unit 112a is a portion of the reflected light of the broad-band light that the first optical source unit 112a provides to the first chirped Bragg grating 124a through the first optical mux/demux 118a. The first optical source unit 112a is connected to an input/output terminal having N channels at one end of the first optical mux/demux 118a, respectively.

The first optical reception unit 114a receives the up-stream signal to convert into an electrical signal. The first optical reception unit 114a may be an ROSA. The first optical reception unit 114a may be connected to the first optical source unit 112a in parallel. A plurality of first optical light reception units Rx1a, Rx2a, . . . , RxNa may be provided. The first optical reception unit 114a may be connected to each channel of the first optical mux/demux 118a.

A first optical filter 116a delivers the optical signal of the first optical source unit 112a to the first optical mux/demux 118a. The first optical filter 116a provides the up-stream signal from the first optical mux/demux 118a to the first optical reception unit 114a. The up-stream signal and the down-stream signal may be different bands. Thus, the up-stream signal is selectively provided to the first optical reception unit 114a by the first optical filter 116a.

The first optical mux/demux 118a may be an Arrayed Waveguide Grating (AWG) or a Waveguide Grating Router (WGR). The first optical mux/demux 118a may include N first input/output terminals disposed at one end thereof, and a second input/output terminal disposed at the other end thereof. The N input/output terminals disposed at the one end of the first optical mux/demux 118a are connected to the first optical source unit 112a and the first optical reception unit 114a. The second input/output terminal disposed at the other end of the first optical mux/demux 118a is connected to the first optical distributor 122a. Light inputted into the first input/output terminal of the first optical mux/demux 118a is multiplexed to provided to the second input/output terminal. Light inputted into the second input/output terminal of the first optical mux/demux 118a is provided to the first input/output terminal according to the channel wavelength.

The first optical mux/demux 118a performs a spectrum slicing on light that is reflected by the first chirped Bragg grating 124a. When the first optical mux/demux 118a includes N channels, channel wavelengths are different for each channel. The first optical mux/demux 118a provides a seed light source of a single wavelength to the first optical source unit 112a. That is, the first optical mux/demux 118a operates the first optical source unit 112a using a specific channel wavelength as a main oscillation wavelength. The first optical source unit 112a is self-injection locked by the first optical mux/demux 118a and the first chirped Bragg grating 124a. Thus, the first optical source unit 112a oscillates in the specific channel wavelength of the first optical mux/demux 118a. The first optical source units Tx1a, Tx2a, . . . , TxNa may oscillate in a different wavelength from each other. The oscillation wavelength of the first optical source units Tx1a, Tx2a, . . . , TxNa may be determined by the channel wavelength of the first mux/demux 118a. Accordingly, the oscillation wavelength of the first optical source unit 112a may depend on a temperature change of the first optical mux/demux 118a. The first optical source unit 112a may not require a separate temperature controller. The first optical mux/demux 118a may include a temperature controller (not shown). The temperature controller may change the channel wavelength of the first optical mux/demux 118a.

The oscillation wavelength and the linewidth of the first optical source unit 112a may depend on the channel wavelength and the channel linewidth of the first optical mux/demux 118a. Since the linewidth of the channel wavelength of the first optical mux/demux 118a is relatively broad, a dispersion may occur during long-distance transmission. Accordingly, in order to compensate the dispersion, the grating period of the first chirped Bragg grating 124a forms a diffraction grating from a long wavelength to a short wavelength with respect to the direction of inputted light to reflect the relatively slow long wavelength before the short wavelength. For example, in the dispersion of the optical fiber 130 at a band of approximately 1,500 nm, a short wavelength may be relatively quicker than a long wavelength. The first chirped Bragg grating 124a may compensate in advance a dispersion that is generated in a long-distance transmission through the optical fiber 130 by reflecting the long wavelength first.

The total length of the first optical source unit 112a, the first optical mux/demux 118a, and the first chirped Bragg grating 124a may be identical to a resonant length of the first optical source unit 112a. The oscillation wavelength of the first optical source unit 112a may be an integer multiple of the resonant length. When the oscillation wavelength of the first optical source unit 112a is identical to an integer multiple of the resonant length, the output of the first optical source unit 112a may be maximum. The first optical source unit 112a may include a phase-shift region (not shown) that changes the refractive index inside the first optical source unit 112a. A voltage applied to the phase-shift region changes the refractive index of the shift region to thereby control a phase of light re-inputted from the first chirped Bragg grating 124a.

The first optical distributor 122a provides the optical signal from the first optical mux/demux 118a to the optical fiber 130 and the first chirped Bragg grating 124a. The first optical distributor 122a provides an up-stream signal from the optical fiber 130 to only the first optical mux/demux 118a. The first optical distributor 122a may be integrally provided with the first optical mux/demux 118a.

The first chirped Bragg grating 124a again reflects the light having passed the first optical mux/demux 118a to re-input a certain portion of the light into the first optical mux/demux 118a and the first optical source unit 112a. The first chirped Bragg grating 124a may have the broad-band reflection characteristics. The first chirped Bragg grating 124a may have the reflection characteristics at a band of the down-stream signal, and may have the transmission characteristics at a band of the up-stream signal.

The first chirped Bragg grating 124a may be formed of an optical fiber. The first chirped Bragg grating 124a may change the fluctuation period of the refractive index gradually according to the length. The first chirped Bragg grating 124a may have the reflection characteristics showing the minimum reflectance at the center wavelength. The reflectance of the first chirped Bragg grating 124a may be more than approximately 50%. For example, the reflection band of the first chirped Bragg grating 124a may range from approximately 1,500 nm to approximately 1,600 nm The first chirped Bragg grating 124a may be formed by gradually changing the effective refractive index. The oscillation wavelength of the first optical source 112a is expressed as Equation (1)

λ=Λ2n_{eff} (1)

Where λ is an oscillation wavelength, Λ is a period of the first chirped Bragg grating 124a, and n_{eff} is an effective refractive index. The period (Λ) may be gradually changed. A desired distribution of the reflectance of the first chirped Bragg grating 124a may be achieved with respect to the wavelength by controlling the etching depth or the number of the diffraction grating.

According to an embodiment, the first optical distributor 122a and the first chirped Bragg grating 124a may be integrally formed with the first optical mux/demux 118a. The first optical mux/demux 118a, the first optical distributor 122a, and the first chirped Bragg grating 124a may be formed of a silica material.

The down-stream signal is inputted into the remote node 101. The remote node 101 includes a second optical mux/demux 118b. The second optical mux/demux 118b divides the inputted signal according to its wavelength to transmit to each optical network unit 102. The second optical mux/demux 118b has the same structure as the first optical mux/demux 118a. The second optical distributor 122b is disposed between the second optical mux/demux 118b and the optical fiber 130. The second optical distributor 122b may have the same structure and perform the same function as the first optical distributor 122a. The second chirped Bragg grating 124b is combined with the optical fiber 130 through the second optical distributor. The second chirped Bragg grating 124b may have the same structure and perform the same function as the first chirped Bragg grating 124a.

The optical network unit 102 includes a second optical filter 116b, a second optical source unit 112b transmitting an up-stream signal, and a second optical reception unit 114b receiving a down-stream signal. The second optical filter 116b may have the same structure and perform the same function as the first optical filter 116a. The second optical source unit 112b may have the same structure as the first optical source unit 112a. The second optical reception unit 114b may have the same structure and perform the same function as the first optical reception unit 114a. The generation principle of the up-stream signal may be identical to that of the down-stream signal.

In a WDM-PON apparatus according to an embodiment of the inventive concept, an optical source unit of a connection device between a central office and an optical network unit may employ a low-cost Fabry-Perot laser diode or semiconductor optical amplifier without a seed light source. Accordingly, the WDM-PON apparatus can minimize the system build-up cost compared to typical optical networks. Since the oscillation wavelength of the optical source unit is determined by an optical mux/demux, it is unnecessary to independently control the temperature of the optical source and the optical mux/demux.

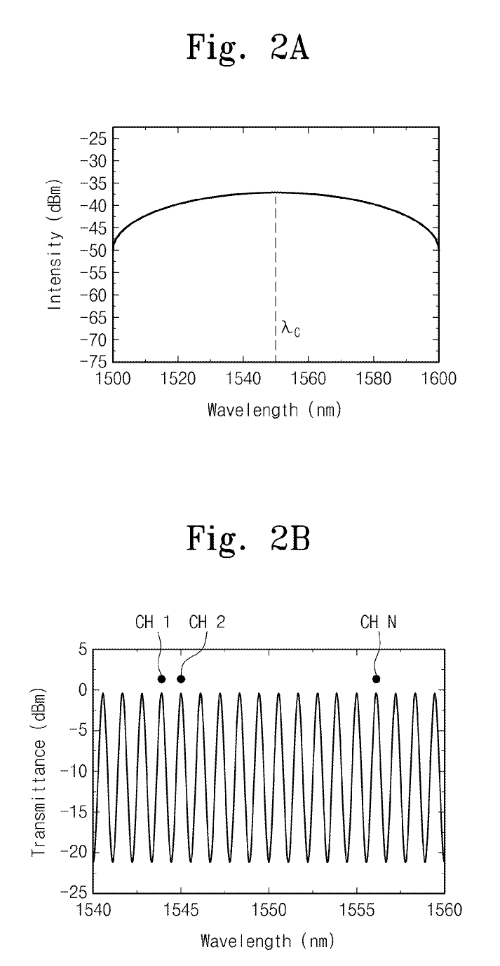

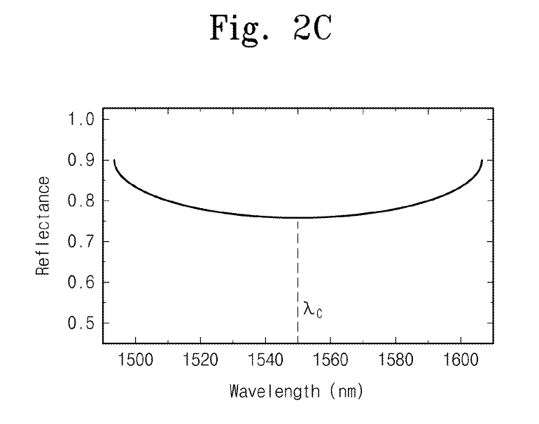

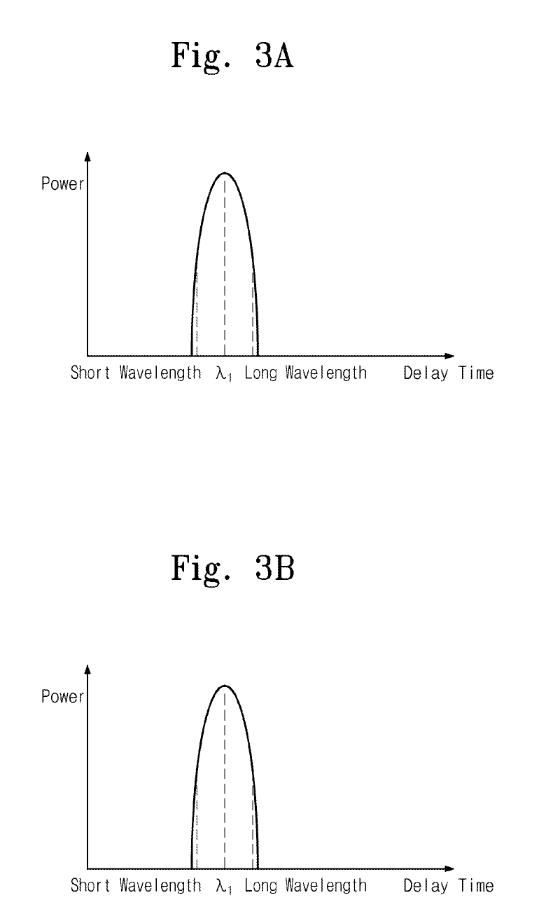

FIGS. 2A through 2C are diagrams illustrating the spectrum characteristics of an optical source unit, an optical mux/demux, and a chirped Bragg grating according to an embodiment.

Referring to FIG. 2A, the optical source unit may provide a broad-band wavelength of approximately 1,500 nm to approximately 1,600 nm The optical source unit may be a colorless optical source. The optical source unit may provide the maximum power at the center wavelength λ_{C}.

Referring to FIG. 2B, the optical mux/demux may perform a function of a band pass filter including a plurality of channels CH1, CH2, . . . , CHN.

Referring to FIG. 2C, the reflectance of the chirped Bragg grating may show the lowest reflection characteristics at the center wavelength λ_{C} of the optical source unit. That is, as getting away from the center wavelength λ_{C}, the chirped Bragg grating may show a higher reflectance. Thus, the first optical source unit provides a high power at the center wavelength, and the first chirped Bragg grating provides a low reflectance at the center wavelength, thereby allowing the first optical source unit and the first chirped Bragg grating to provide a uniform power with respect to a certain band.

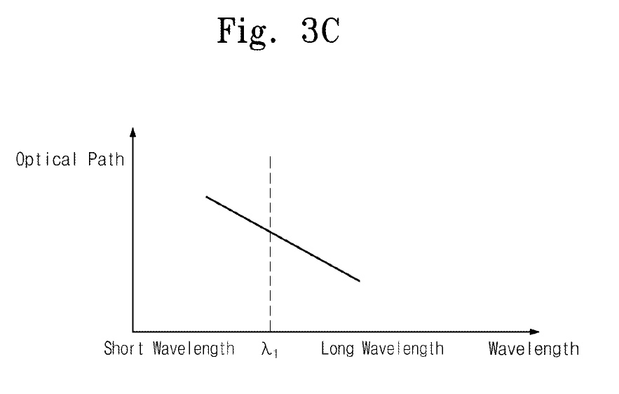

FIGS. 3A through 3C are diagrams illustrating the dispersion characteristics of an optical source unit, an optical fiber, and a chirped Bragg grating according to an embodiment.

Referring to FIG. 3A, power according to delay time of the optical source unit may be maximum at the channel wavelength λ 1. A frequency distortion may occur due to the dispersion of the optical source unit. The delay time may be defined as a certain distance/group speed.

Referring to FIG. 3B, an output power according to delay time of the optical fiber may be maximum at the channel wavelength λ 1. A frequency distortion may occur due to the dispersion of the optical fiber.

Referring to FIG. 3C, the optical path of the chirped Bragg grating may decrease as the wavelength increases. The optical path may be the total path through which light incident to the chirped Bragg grating is reflected to return. A short wavelength may have a long path, and a long wavelength may have a short path.

As the transmission distance of the optical fiber increases, a short wavelength may be more quickly propagated by the dispersion than a long wavelength. Thus, the optical pulse width may be broadened according to the lapse of time. If the central office and the remote node compensate the dispersion of the optical fiber in advance, the optical fiber may realize the long-distance transmission.

Since the linewidth of the channel wavelength of the first optical mux/demux 118a is finite, the channel linewidth of the pulse generated in the optical source unit may have a finite range. The chirped Bragg grating may be formed by gradually reducing the grating period with respect to the inputted light. The chirped Bragg grating may reflect a relatively slow long wavelength before a short wavelength. The reflection characteristics may be provided by controlling the grating period of the chirped Bragg grating. Accordingly, the dispersion generated from the long-distance transmission may be compensated by the central office or the remote node in advance. Thus, the optical fiber may provide the long-distance transmission. The chirped Bragg grating may be configured to compensate the dispersion by the optical source unit and the optical fiber.

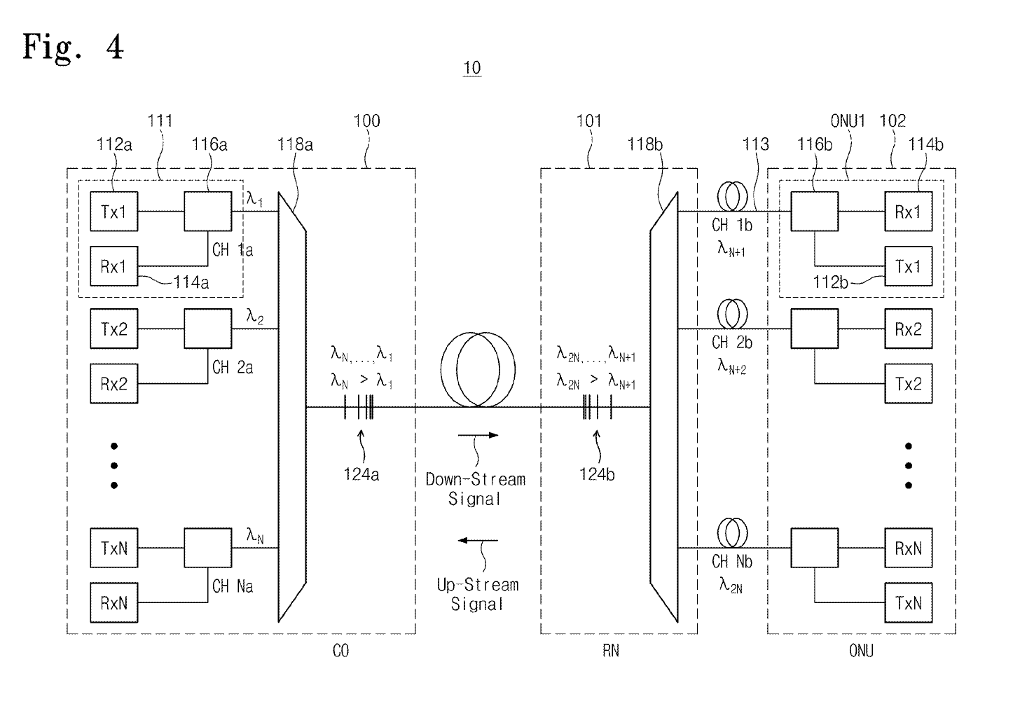

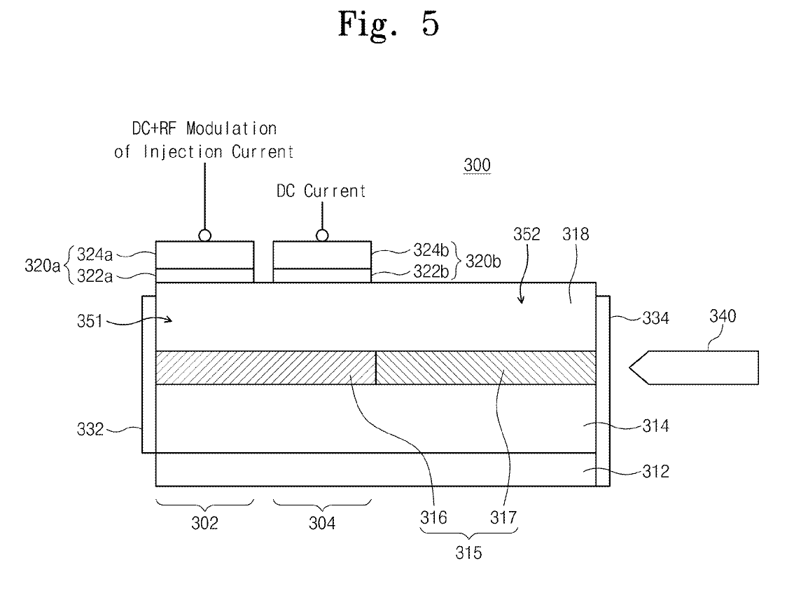

FIG. 4 is a diagram illustrating a WDM-PON apparatus according to another embodiment. Detailed descriptions of parts identical to those in FIG. 1 will be omitted below.

Referring to FIG. 4, a WDM-PON apparatus 10 may include a first optical source unit 112a, a first optical mux/demux 118a, and a first chirped Bragg grating 124a. The first optical source unit 112a generates an optical signal. The first optical mux/demux 118a receives the optical signal from the first optical source unit 112a via one end thereof, and multiplexes the optical signal to output. The first chirped Bragg grating 124a is connected to the other end of the first optical mux/demux 118a. The first chirped Bragg grating 124a reflects again the light having passed the first optical mux/demux 118a to return certain portions of the light to the first optical mux/demux 118a and the first optical source unit 112a. The first optical mux/demux 118a performs a spectrum slicing on the returned light. The first optical mux/demux 118a operates the first optical source unit 112a using a channel wavelength of the first optical mux/demux 118a as a main oscillation wavelength. Thus, the first optical source unit 112a is self-injection locked.

The WDM-PON apparatus 10 includes a central office (CO) 100, an optical fiber 130, a remote node (RN) 101, and an optical network unit (ONU) 102.

The central office 100 includes a first optical source unit 112a transmitting a down-stream signal, a first optical reception unit 114a receiving an up-stream signal, a first optical filter 116a, and a first optical mux/demux 118a. A plurality of first optical source units 112a may be provided. The first optical source units Tx1a, Tx2a, . . . , TxNa are connected to each channel of the first optical mux/demux 118a.

The central office 100 may include the first chirped Bragg grating 124a. The central office 100 provides a down-stream signal to a second optical mux/demux 118b in the remote node 101, and receives an up-stream signal from the remote node 101.

The first chirped Bragg grating 124a is directly connected to an optical fiber and the first optical mux/demux 118a. The first chirped Bragg grating 124a again reflects light having passed the first optical mux/demux 118a to re-input a certain portion of the light into the first optical mux/demux 118a and the first optical unit 112a. The first chirped Bragg grating 124a may have the broad-band reflection characteristics. The first chirped Bragg grating 124a may have the reflection characteristics at a band of the down-stream signal, and may have the transmission characteristics at a band of the up-stream signal. The reflectance of the first chirped Bragg grating 124a may range from approximately 5% to approximately 99%.

The down-stream signal is inputted into the remote node 101 through the optical fiber 130. The remote node 101 includes a second optical mux/demux 118b. The second optical mux/demux 118b divides the inputted light according to its wavelength to transmit to each optical network unit 102. The second optical mux/demux 118b has the same structure as the first optical mux/demux 118a. The second chirped Bragg grating 124b is directly connected to the optical fiber and the second optical mux/demux 118b.

The grating period of the chirped Bragg grating contributes to the dispersion compensation of the optical fiber by reflecting a relatively slow long wavelength of an inputted light before a short wavelength. Thus, the optical fiber can achieve the long-distance transmission.

FIG. 5 is a cross-sectional view illustrating an optical source unit according to an embodiment.

Referring to FIG. 5, an optical source unit 300 includes a substrate 314, a core layer 315, and a clad layer 318, which are sequentially stacked over a lower ohmic metal 312. The core layer 315 includes an active layer 316 and a passive layer 317. The active layer 316 and the clad layer 318 provide a gain waveguide 351. The passive layer 317 and the clad layer 318 provide a passive waveguide 352. The active layer 316 and the passive layer 317 are disposed on the same plane.

The substrate 314 may include an n-type InP. The clad layer 318 may include a p-type InP.

The active layer 316 may include a gain region 302 and a phase shift region 304. The active layer 316 may include InGaAsP. The passive layer 317 may include InGaAsP. The band gap of the active layer 316 may be smaller than the band gap of the passive layer 317. Thus, light generated in the active layer 316 may travel without being absorbed to the passive layer 317.

A current injection terminal 320a and a phase control terminal 320b may be disposed spaced from each other over the active layer 316. The current injection terminal 320a and the phase control terminal 320b are separated from each other to provide an independent current injection. The current injection terminal 320a may be disposed over the gain region 302. The phase control terminal 320b may be disposed over the phase shift region 304.

The current injection terminal 320a may include an ohmic layer 322a and an upper ohmic metal layer 324a, which are sequentially stacked. The current injection terminal 320a may inject a DC current and an RF current. A voltage applied to the current injection terminal 320a may be a DC+RF modulation voltage. The current injected by the current injection terminal 320a may provide an optical gain.

The phase control terminal 320b may include an ohmic layer 322b and an upper ohmic metal layer 324b, which are sequentially stacked. A voltage applied to the phase control terminal 320b may be a DC voltage. A current injected to the phase control terminal 320b may change the refractive index of a material under the phase control terminal 320b. Thus, the phase control terminal 320b may control the phase of light passing through the gain waveguide 351.

The gain waveguide 351 and the passive waveguide 352 may be butt-jointed. The passive wavelength 352 may be connected to a Spot Size Converter (SSC). A high reflection layer 332 may be disposed at one end of the optical source unit 300. A non-reflection layer 334 may be disposed at the other end of the optical source unit 300. The optical fiber 340 may be disposed adjacent to one end of the passive wavelength 352. Light incident through the optical fiber 340 may be incident to the optical source unit 300 without any reflection. The phase of the incident light traveling the optical source unit 300 may be controlled at the phase shift region 304.

The total length of the optical source unit, the optical mux/demux, and the chirped Bragg grating may provide the total resonant length of the optical source unit. When the oscillation wavelength of the optical source unit is an integer multiple of the resonant length, the maximum output power may be generated. The phase shift region 304 may allow the oscillation wavelength to be an integer multiple of the resonant length.

According to an embodiment of inventive concept, the phase shift region 304 may be formed at the passive waveguide 352 rather than the gain waveguide 351.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A wavelength division multiplexed-passive optical network (WDM-PON) apparatus comprising:
an optical source unit generating an optical signal;
an optical mux receiving the optical signal from the optical source unit through one end of the optical mux, multiplexing the optical signal, and outputting the multiplexed optical signal; and
a chirped Bragg grating connected to the other end of the optical mux,
wherein the chirped Bragg grating again reflects the optical signal having passed the optical mux to re-input a certain portion of the optical signal into the optical mux and the optical source unit, and the optical mux performs a spectrum slicing on the re-inputted optical signal and operates the optical source unit using a channel wavelength of the optical mux as a main oscillation wavelength.

2. The WDM-PON apparatus of claim 1, wherein the chirped Bragg grating has a grating period that is gradually reduced from an entrance of the chirped Bragg grating to reflect a long wavelength first.

3. The WDM-PON apparatus of claim 1, wherein the optical source unit provides a high power at the center wavelength, and the chirped Bragg grating provides a low reflectance at the center wavelength, thereby allowing the optical source unit and the chirped Bragg grating to provide a uniform power with respect to a certain band.

4. The WDM-PON apparatus of claim 1, wherein the optical source unit comprises a gain region and a phase shift region, the phase shift region controlling a phase of the optical signal reflected from the chirped Bragg grating.

5. The WDM-PON apparatus of claim 4, wherein the optical source unit comprises a gain waveguide and a passive waveguide, the phase shift region formed on the gain waveguide or the passive waveguide and controlling the phase of the optical signal reflected from the chirped Bragg grating.

6. The WDM-PON apparatus of claim 1, wherein the total length of the optical source unit, the optical mux, and the chirped Bragg grating is an integer multiple of an oscillation wavelength of the optical source unit.

7. The WDM-PON apparatus of claim 1, wherein the chirped Bragg grating is a chirped optical fiber grating.

8. The WDM-PON apparatus of claim 7, wherein the chirped optical fiber grating is integrally formed with the optical mux.

9. The WDM-PON apparatus of claim 1, wherein the optical source unit comprises at least one of a Fabry-Perot laser diode (FP-LD), a reflective semiconductor optical amplifier (RSOA), a superluminescent diode (SLD), and a vertically-cavity surface-emitting laser (VCSEL).
